(19) United States
(12) Patent Application Publication
(10) Pub. No.: US 2009/0063247 A1
(43) Pub. Date: Mar. 5, 2009

(54) METHOD AND SYSTEM FOR COLLECTING AND CLASSIFYING OPINIONS ON PRODUCTS

(75) Inventors: David Burgess, Menlo Park, CA (US); Laurent DeNoue, Palo Alto, CA (US); Jonathan Trevor, Santa Clara, CA (US)

Correspondence Address: FIALA & WEAVER, P.L.L.C.;C/O INTELLEVATE, P.O. BOX 52050, MINNEAPOLIS, MN, 55402, US

(73) Assignee: YAHOO! INC., Sunnyvale, CA (US)

(21) Appl. No.: 11/846,078

(22) Filed: Aug. 28, 2007

(51) Int. Cl. G06Q 30/00; G06F 17/30

(52) U.S. Cl. 705/10

(57) ABSTRACT

Methods, systems, and apparatuses for generating and providing review information for products are described. Product reviews for a product are collected from multiple websites over the Internet. The product reviews may be collected in any manner, such as by crawling the Internet to collect product review information for the product. Review information may be collected for multiple versions/releases of the product. Websites, RSS feeds, consumer reports, and other Internet sources may be parsed for product reviews for the product. Product reviews and product review ratings received from multiple websites may be weighted and normalized into common form. Product reviews may be weighted based on a reputation of the reviewers who submitted them. Product reviews may also be filtered based on time of submission. One or more summary ratings for the product are generated based on the collected product reviews. The summary ratings are displayed.

### BACKGROUND OF THE INVENTION

1. Field of the Invention

The present invention relates generally to product reviews, and in particular, to summary product reviews generated from Internet based content.

2. Background Art

Consumers are spending increasingly more time viewing content on the Internet. Many Internet websites are dedicated to enabling consumers to shop. For example, the Internet provides a convenient way for consumers to search for products, perform comparison shopping, and read reviews of products that they are considering purchasing. The availability of product reviews on the Internet has increased the appeal of Internet shopping to many consumers.

However, Internet sites that provide product reviews have deficiencies. For example, such sites typically have an insufficient number of user reviews to produce statistically significant results. Thus, biased feedback provided by a small number of individuals can adversely affect the overall results in a significant way. Furthermore, reviews of early product releases do not take into account more recent fixes to the product and up-to-date functionality of the product.

Thus, what is desired are ways of providing product reviews to consumers over the Internet in an improved manner.

### BRIEF SUMMARY OF THE INVENTION

Methods, systems, and apparatuses for generating and providing review information for products are described. Product reviews for a product are collected from multiple websites over the Internet. One or more summary ratings for the product are generated based on the collected product reviews. The summary ratings are displayed.

In a further aspect, product reviews submitted by reviewers determined to have undesired reputations may be discounted. Furthermore, product reviews may be weighted according to the time at which they are submitted.

In another aspect of the present invention, a system for generating review information for products is provided. The system includes a product review information collector, a summary ratings generator, and a user interface. The product review information collector is configured to collect product reviews provided at multiple websites over the Internet. The summary ratings generator is configured to generate one or more summary ratings and associated statistics for products based on collected product reviews for the products. The user interface is configured to display summary ratings for products.

In an example, the product review information collector includes a web crawler. The web crawler receives a product catalog that lists a plurality of products in a product domain and a plurality of product names for each product. The web crawler crawls the Internet to collect product review information for selected products of the product catalog.

In another example, the product review information collector includes a product review information parser. The product review information parser is configured to parse various Internet based sources of information for product reviews. For example, the product review information parser parses a Real Simple Syndication (RSS) feed for a name of a selected product and at least one adjective that provides a review indication for the selected product. In another example, the product review information parser parses website content on Internet web sites for the name of the selected product and the adjective(s). In still another example, the product review information parser parses one or more selected consumer reports, blogs, and/or podcasts for the name of the selected product and the adjective(s).

In another example, the summary ratings generator includes a product review normalizer that receives and normalizes the received product reviews.

In a further example, the summary ratings generator includes a review category mapper. The review category mapper receives a plurality of category-specific reviews for a product, and maps the plurality of category-specific reviews for the product to one or more product review categories maintained for the product.

In a further example, the summary ratings generator is configured to discount product reviews received from reviewers determined to have undesired reputations.

In a still further example, the summary ratings generator includes a product review combiner. The product review combiner combines (e.g., averages) a plurality of normalized product reviews for a product into a summary rating for the product.

In a still further example, the summary ratings generator includes a summary rating analyzer that determines statistics regarding the summary ratings.

In a still further example, the user interface is configured to enable a user select, sort, filter, and display summary ratings and various product review information.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a product review aggregation system, according to an embodiment of the present invention.

FIG. 2 shows a flowchart providing example steps for operation of a product review aggregation system, according to an example embodiment of the present invention.

FIG. 3 shows a block diagram of a product review information collector, according to an example embodiment of the present invention.

FIG. 4 shows a flowchart providing steps for collecting product review information, according to an example embodiment of the present invention.

FIG. 5 shows a flowchart providing steps for parsing collected product review information, according to an example embodiment of the present invention.

FIGS. 6 and 7 shows block diagrams of example summary rating information generators, according to example embodiments of the present invention.

FIG. 8 shows a block diagram for generating summary rating information, according to an example embodiment of the present invention.

FIG. 9 shows example summary rating data for a product, according to an embodiment of the present invention.

FIG. 10 shows an example block diagram of a user interface, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### EXAMPLE EMBODIMENTS

The example embodiments described herein are provided for illustrative purposes, and are not limiting. Further structural and operational embodiments, including modifications/alterations, will become apparent to persons skilled in the relevant art(s) from the teachings herein.

Embodiments of the present invention gather reviewer feedback/reviews/opinions on a product from multiple Internet sites. Consumers are enabled to gather and assess the world's opinions provided on the Internet for products. The quality of overall ratings is improved. Reviewer feedback is aggregated and normalized. The feedback can be weighted based on various factors, such as the time the review is submitted. For example, if a review is submitted during a time at which an early release of a product is available, the review may not be as relevant at a time when newer releases of the product are available. In another example, the feedback can be weighted based on a reputation of the reviewer. For example, some reviewers may be known to be biased for or against a product. Product reviews provided by undesired reviewers, such as those financially connected to a product in the domain, may be discounted relative to other product reviews for a particular product. Product reviews provided by respected reviewers, such as those that provide independent advice and recommendations in consumer reports, may be weighted higher relative to other product reviews for a particular product.

Product reviews generally include files or portions of files (e.g., text, graphics, video and/or voice) submitted by reviewers that evaluate a particular product. Typically, a reviewer of a product is familiar with the product, and thus is capable of generating a product review with evaluation information that may be useful to others who are considering using and/or buying the product. Product reviews may be available in separate files or in lists within files or in RSS feeds, etc.

Embodiments are applicable to all types of products, including tangible products and intangible products (e.g., services). Example tangible products include articles of clothing, automobiles, boats, books, compact discs (CDs), cosmetics, digital video discs (DVDs), electronic devices (e.g., phones, music players, computers and peripherals, cameras, etc.), food, furniture, homes, instruments, jewelry, motorcycles, pets, pharmaceuticals, software, tools, toys, etc. These example products are provided for purposes of illustration and are not intended to be limiting.

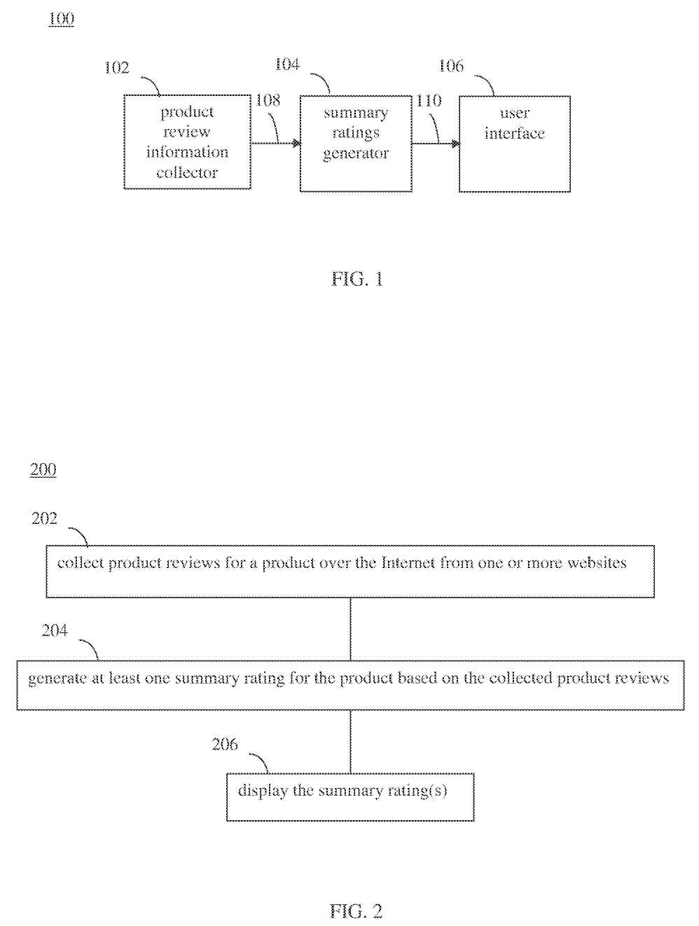

For example, FIG. 1 shows a block diagram of a product review aggregation system 100, according to an embodiment of the present invention. As shown in FIG. 1, product review aggregation system 100 includes a product review information collector 102, a summary ratings generator 104, and a user interface 106. Product review aggregation system 100 collects product reviews from Internet-accessible sites, aggregates the product reviews, and enables a user to view aggregated product review information.

FIG. 2 shows a flowchart 200 providing example steps for operation of product review aggregation system 100, according to an example embodiment of the present invention. Other structural and operational embodiments will be apparent to persons skilled in the relevant art(s) based on the discussion regarding flowchart 200. Flowchart 200 is described as follows.

Flowchart 200 begins with step 202. In step 202, product reviews are collected for a product over the Internet from multiple websites. In an embodiment, product review information collector 102 of FIG. 1 performs step 202. Product review information collector 102 is configured to collect product reviews provided at multiple websites over the Internet. In an embodiment, collector 102 collects product review information from a predetermined list of websites, such as websites well known to provide product reviews, including shopping.yahoo.com, www.epinions.com, www.amazon.com, www.consumerreports.org, etc. Alternatively and/or additionally, collector 102 may search the Internet for product reviews from websites in a wide-ranging fashion. Collector 102 parses received files (e.g., HTML documents, RSS feeds, etc.) that include product review information to extract the product reviews. Collector 102 outputs product reviews 108, which may include a stream of individual product reviews, or a list, table, or other data structures providing multiple product reviews.

In step 204, at least one summary rating is generated for the product based on the collected product reviews. In an embodiment, summary ratings generator 104 performs step 204. Summary ratings generator 104 is configured to generate one or more summary ratings for products based on multiple product reviews for the products collected by collector 102. Summary ratings generator 104 receives product reviews 108 from collector 102, which may include product reviews in the same or different formats, and/or which may include product reviews that contain different review categories from each other. In an embodiment, summary ratings generator 104 normalizes the collected product reviews into a common format. Summary ratings generator 104 generates summary ratings for products based on the collected product reviews. Furthermore, summary ratings generator 104 may generate statistical information regarding the generated summary ratings, such as statistical significance information, accuracy of ratings based on number of reviews, distribution of ratings including minimum, first quartile, average, median, third quartile and maximum rating. Summary ratings generator 104 outputs summary rating data 110, which may include generated summary ratings, product reviews, and optionally generated statistical information.

In step 206, the summary rating(s) is/are displayed. In an embodiment, user interface 106 performs step 206. User interface 106 is configured to display summary ratings generated by summary ratings generator 104 for products. User interface 106 receives summary rating data 110, and enables a user to display the included summary ratings, product reviews, statistical information regarding products. In an embodiment, user interface 106 enables a user to select data to be displayed, to sort and/or filter data, and/or to otherwise manipulate data to be displayed, and/or view statistical information on subsets of data (for example, reviews and ratings within a geographic region or timeline or category). In embodiments, user interface 106 includes one or more user interface output elements such as a display device (e.g., a video monitor, flat screen or otherwise), an output audio device, one or more output indicators (e.g., LEDs), etc. Furthermore, user interface 106 may include one or more user interface input elements such as a keyboard, a mouse, a touchpad, a rollerball, etc., for a user to interact with the received summary rating data 110.

Product review information collector 102, summary ratings generator 104, and user interface 106 may be implemented in hardware, software, firmware, of any combination thereof. For example, product review information collector 102, summary ratings generator 104, and user interface 106 may each be implemented in digital logic, such as in an integrated circuit (e.g., an application specific integrated circuit (ASIC)), in code configured to execute in one or more processors, and/or in other manner as would be known to persons skilled in the relevant art(s). For example, a computer system is described further below that may be used to implement system 100.

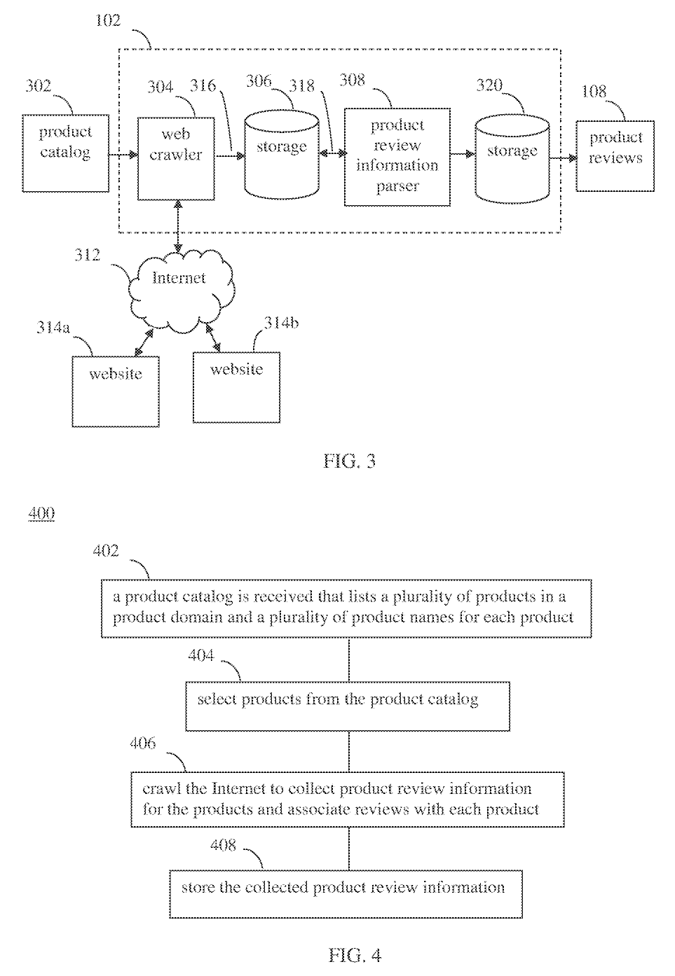

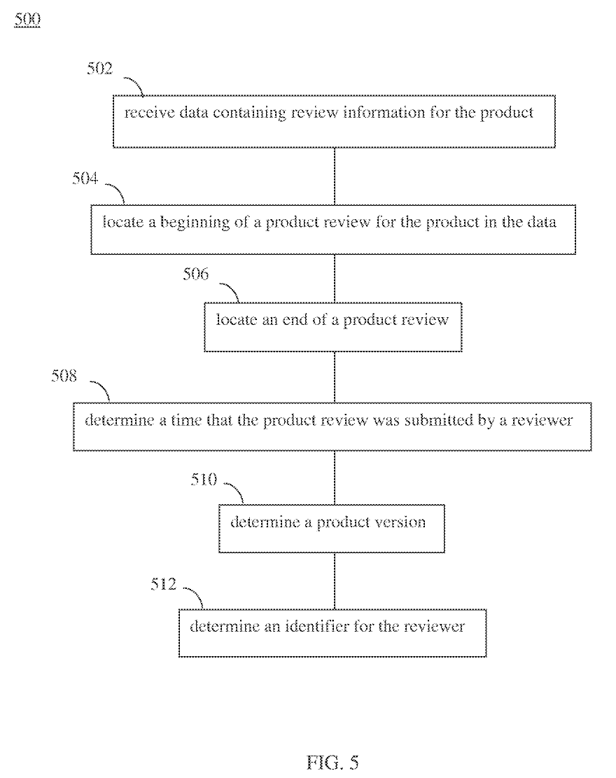

FIG. 3 shows an example embodiment for product review information collector 102. As shown in FIG. 3, product review information collector 102 includes a web crawler 304, storage 306, a product review information parser 308, and storage 320.

Web crawler 304 is configured to crawl the Internet to collect product review information for products. For example, in an embodiment, web crawler 304 performs the steps of flowchart 400 shown in FIG. 4 to collect product review information. Flowchart 400 is described as follows.

In step 402, a product catalog is received that lists a plurality of products in a product domain and a plurality of product names for each product. The product catalog can also include product release dates in each geographic region, and corresponding manufacturer(s) and distributor(s). As shown in FIG. 4, web crawler 304 receives a product catalog 302. For example, product catalog 302 may be a product catalog available in electronic form, such as a web-based product catalog that may retrieved from a website over the Internet, or may be a non-electronic (e.g., paper) product catalog that is scanned into electronic form for use by web crawler 304.

In step 404, products are selected from the product catalog. In an embodiment, web crawler 304 may parse product catalog 302 for listed products. Web crawler 304 may be configured to select and collect product reviews for all products listed in product catalog 302, or for any portion of the listed products.

In step 406, the Internet is crawled to collect product review information for the products and associate reviews with each product. In an embodiment, web crawler 304 performs step 406. Web crawler 304 may be a special purpose or conventional “spidering engine” or web crawler (e.g., hardware, software program, and/or automated script) configured to browse the World Wide Web in a methodical, automated manner. For example, as shown in FIG. 3, web crawler 304 accesses a plurality of websites 314 through the Internet 312 for product review information for selected products. Web crawler 304 typically makes copies of relevant visited pages of websites 314 for later processing by product review information parser 308, etc. In an embodiment, web crawler 304 may locate and collect HTML documents, information from RSS feeds and/or other streaming content sources, and other sources of information.

In an embodiment, web crawler 304 may be configured to crawl specific websites 314 according to a stored list of relevant websites. The websites in the list may be websites known to provide product reviews, consumer reports, etc., such as www.yahoo.com, www.epinions.com, www.amazon.com, www.consumerreports.org, etc. Alternatively, web crawler 304 may be configured to crawl websites 314 of Internet 312 in a wide-ranging fashion to collect product reviews. As shown in FIG. 3, web crawler 304 outputs product review information 316.

In step 408, the collected product review information is stored. For example, as shown in FIG. 3, web crawler 304 stores product review information 316 in storage 306. Storage 306 may include any type of storage device, including one or more mass storage devices (e.g., hard drives, optical discs, etc.) and/or memory devices (e.g., static RAM (SRAM), dynamic RAM (DRAM), etc.).

As shown in FIG. 3, product review information parser 308 communicates with storage 306 over a communication link 318, which may include any type of computer and/or network connection. Product review information parser 308 requests stored product review information from storage 306 over communication link 318. Stored product review information is provided by storage 306 to product review information parser 308 over communication link 318. Product review information parser 308 is configured to parse through the product review information to extract product reviews. For example, product review information parser 308 removes extraneous information from the collected product review information. As shown in FIG. 3, product review information parser 308 may store extracted product reviews in storage 320, which may be the same or a different storage device/mechanism from storage 306.

In an embodiment, product review information parser 308 locates a product review in a file by parsing the file for a name of the selected product and one or more adjectives and/or one or more nouns that provide a review indication for the selected product. For example, product review information parser 308 may textually search a file for the product name “IPod” when searching for an APPLE IPOD product. Furthermore, product review information parser 308 may textually search a file for one or more adjectives typically used in a review, such as “excellent” or “poor” to locate a product review portion of a file. Product review information parser 308 may additionally or alternatively textually search a file for one or more nouns used as review categories, such as “quality” or “reliability” to locate a product review portion of a file. The parser can also use machine learning techniques to learn predicates and a corresponding impact these have on the category ratings.

For instance, product review information parser 308 may perform one or more of the steps in flowchart 500 shown in FIG. 5 to parse product review information for a product review. Flowchart 500 is described as follows.

In step 502, data is received containing review information for the product. For instance, as shown in FIG. 4, product review information parser 308 receives such data from storage 306, or alternatively may receive data directly from web crawler 304.

In step 504, a beginning of a product review for the product is located in storage. In one example, a file containing review information for the product received in step 502 may be an HTML web page document. Product review information parser 308 parses the HTML document to locate a start of a product review portion of the document (e.g., after unneeded header information, etc., in the document).

In step 506, an end of a product review is located. In the current example, product review information parser 308 parses the HTML document to locate an end of a product review portion of the document. This may enable potentially unneeded information in the document following the product review portion to be subsequently removed.

In step 508, a time that the product review was submitted by a reviewer is determined. In the current example, product review information parser 308 parses the HTML document for time and/or date information related to a product review.

In step 510, a version of the product is determined. In the current example, product review information parser 308 parses the HTML document for a version/release information for the product described in the product review.

In step 512, an identifier for the reviewer is determined. In the current example, product review information parser 308 parses the HTML document for an identifier for the reviewer who submitted the located product review, such as an actual name for the reviewer, a login or screen name for the reviewer, etc.

Note that in an embodiment, steps 504-512 may be performed on data obtained from websites having a predetermined product review format, including HTML documents, XML, JSON and RSS feeds. Thus, knowledge of the product review format may be used to aid in determining beginning and end locations for a product review, a time that the product review was submitted, an identifier for the reviewer, and the product release. Alternatively, steps 504-512 may be performed on data that include product reviews of unknown formats.

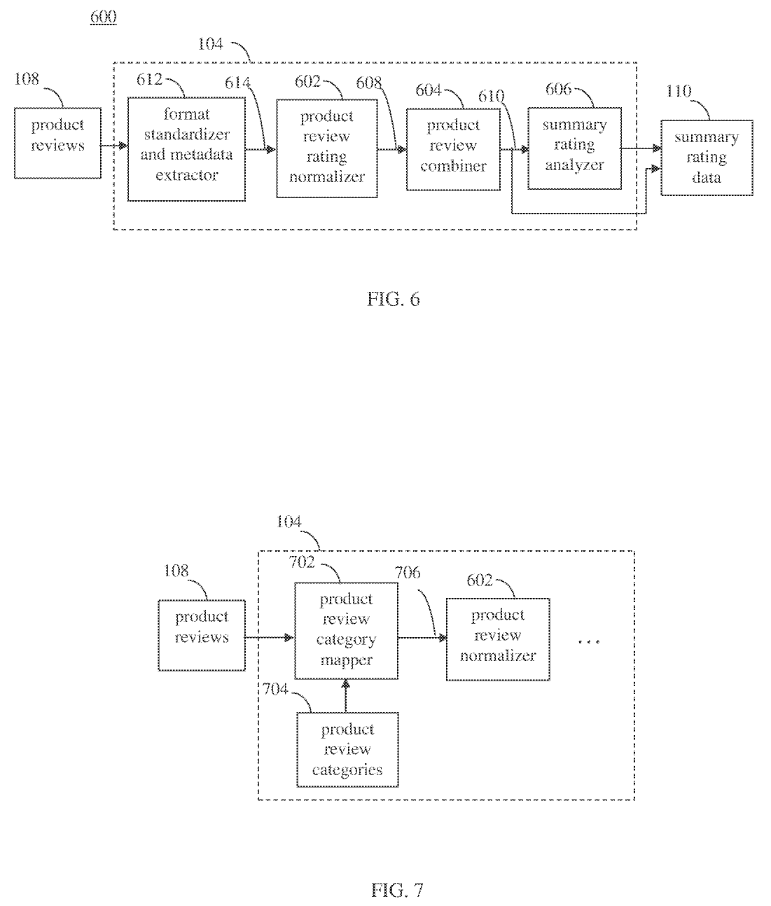

As shown in FIG. 3, product review information parser 308 outputs product reviews 108. As shown in FIG. 1, products review 108 is received by summary ratings generator 104. FIG. 6 shows an example embodiment for summary ratings generator 104. As shown in FIG. 6, summary ratings generator 104 includes a format standardizer and metadata extractor 612, a product review rating normalizer 602, a product review combiner 604, and a summary rating analyzer 606.

Format standardizer and metadata extractor 612 is configured to receive product reviews 108 collected by collector 102 of FIG. 1 for products, to convert product reviews 108 into a standard review format, and to extract metadata from product reviews 108. For example, format standardizer and metadata extractor 612 may convert different reviews into a common review format having standardized review fields, such as those fields mentioned below. Format standardizer and metadata extractor 612 outputs standardized product reviews 614, which includes one or more standardized product reviews for products, with metadata extracted.

Product review rating normalizer 602 is configured to receive standardized product reviews 614 generated by format standardizer and metadata extractor 612, and to normalize the format and ratings of the received product reviews from each web site. For example, normalizer 602 may apply a normalizing factor to a particular review ratings provided in category, numerical, or star form to generate normalized product review ratings in a standard format. In another embodiment, normalizer 602 may include a natural language processing engine that receives a textual product review, analyzes the textual product review, and converts the text into normalized product review ratings. In still another embodiment, a product review may include both a numerical rating and a textual rating, which are both normalized into a single normalized product review rating. Using these techniques, different types of product reviews 108 received from different Internet sources can be converted to a standard rating system, and can be subsequently compared to each other and/or combined to generate summary review ratings for a product. As shown in FIG. 6, normalizer 602 outputs normalized product review ratings 608, which includes one or more normalized product review ratings for products.

For example, in an embodiment, the following product review may be received by normalizer 602 that was collected from a website having a known product review format:

| | |
|---|---|
| product: | Ipod model X |
| product rating: | 4 out of 5 stars |
| time submitted: | 11:30 am, Jul. 12, 2006 |
| reviewer identifier: | PLopez |
| review source: | www.yahoo.com |

In an embodiment, normalizer 602 converts the product review rating into a standard rating. For example, the received review rating system for a particular product (e.g., an Ipod model X) may be a 0-5 star rating, while the standard review rating system maintained by product review normalizer 602 may be a 1-10 numerical scale. In such an embodiment, normalizer 602 may apply a normalization factor, N, to normalize the product review. In the above example, the received rating of 4 out of 5 stars may be normalized using a normalization factor of 2, as follows:

$$\begin{matrix}normalized rating = N \times received rating \\ = 2 \times 4 \\ = 8\end{matrix}$$

Thus, in the current example, a received product rating of 4 out of 5 stars is normalized to a rating of 8 out of 10.

Note that in embodiments, normalization functions can be used to map received ratings into the standard rating system.

In another embodiment, as described above, normalizer 602 may receive a textual portion of a standardized product review and analyze the text to determine the rating. For example, the following standardized product review may be received by normalizer 602 that was collected from a website that provides textual product reviews:

| | |
|---|---|
| product: | Ipod model Y |
| product rating: | The new 4th generation iPod is by far the best. The new |
| | price is of course satisfying as well. In this iPod, the four |
| | annoying buttons are gone, as they were rather difficult |
| | to use on the fly. Now they have the clickwheel, like |
| | on the ipod Mini, which is virtually flawless. |
| time submitted: | 9:30 am, Jul. 22, 2004 |
| reviewer | andrew12 |
| identifier: | |
| review source: | www.amazon.com |

Product review rating normalizer 602 may include a natural language processing engine/module to rate the review. For instance, in the above example, product review rating normalizer 602 may parse the product rating text for adjectives, such as “best” annoying” “difficult” “flawless” etc. Product review rating normalizer 602 further analyzes the product rating text for the context in which the identified adjectives were used. Product review rating normalizer 602 generates a product review rating in the standard rating system.

In another embodiment, a product review may be received that includes multiple review categories. For example, the following product review may be received from a website that has a known product review format:

| | |
|---|---|
| product: | Ipod model Z |
| overall product rating: | 5 out of 5 |
| sound rating: | 4 out of 5 |
| ease of use rating: | 5 out of 5 |
| durability rating: | 4 out of 5 |
| portability rating: | 4 out of 5 |
| battery life rating: | 4 out of 5 |
| time submitted: | 06:11 pm, May 1, 2006 |
| reviewer identifier: | GHilton |
| review source: | www.epinions.com |

As shown above, the received product review for Ipod model Z includes six review categories—sound, ease of use, durability, portability, battery life, and an overall product rating. In an embodiment, as shown in FIG. 7, summary ratings generator 104 may include a product review category mapper 702. Review category mapper 702 maps the plurality of category-specific ratings received for a product to one or more standard product review categories recognized by normalizer 602 for the product. For example, as shown in FIG. 7, mapper 702 may receive product review categories 704. Product review categories 704 includes one or more product review categories that are recognized by normalizer 602. Review category mapper 702 maps the plurality of category-specific ratings received in the product review to the one or more product review categories maintained in product review categories 704. The resulting mapped product ratings are output as mapped product reviews 706.

For instance, continuing the above example, product review categories 704 may include the following mapping:

| received category | mapped, maintained categories |
|---|---|
| sound | quality |
| ease of use | quality |
| durability | reliability |
| portability | quality |
| battery life | reliability |
| overall product rating | overall product rating |

In this example, “sound” “ease of use” and “portability” are all mapped to a “quality” review category. “Durability” and “battery life” are mapped to a “reliability” review category, and “overall product rating” is mapped to an “overall product rating” review category (or can be considered to not be mapped).

According to the current example, mapper 702 may map the above categories in a variety of ways. For example, with regard to “quality,” equal weighting may be given to each received category:

$$\begin{matrix}mapped rating = \sum category rating / \# category ratings \\ = ( sound + ease of use + portability ) / 3 \\ = ( 4 + 5 + 4 ) / 3 \\ = 4.33 ( out of 5 )\end{matrix}$$

In this example, the mapped rating of 4.33 for quality may be provided to normalizer 602 in mapped product review 706. Alternatively, each received category rating may be weighted differently (e.g., with a constant or curved function), as in the following example:

$$\begin{matrix}mapped rating = \frac{\sum ( CW i \times category rating ( i ) )}{\# of category ratings} \\ = ( \begin{matrix}{CW}_{1} \times sound + {CW}_{2} \times \\ ease of use + {CW}_{3} \times portability\end{matrix} ) / 3 \\ = ( ( 1.0 ) 4 + ( 1.2 ) 5 + ( 0.8 ) 4 ) / 3 \\ = 4.4 ( out of 5 )\end{matrix}$$

$$where$$

$$CW i = weight factor for rating category i .$$

In this example, a mapped rating of 4.4 for quality may be provided to normalizer 602 in mapped product review 706. In a likewise fashion, mapped ratings for reliability and overall product rating can be generated, and provided to normalizer 602 in mapped product review 706.

“Quality” “reliability” and “overall product rating” are categories recognized by normalizer 602. Thus, in an embodiment, normalizer 602 may be configured to normalize the “quality” “reliability” and “overall product rating” category ratings received in mapped product review 706 into a unified product rating for the particular product review. In another embodiment, normalizer 602 may be configured to normalize each of the ratings for quality” “reliability” and “overall product rating” into separate normalized ratings.

Note that in another embodiment, mapper 702 may be configured to map all received review categories, such as “sound” “ease of use” “durability” “portability” “battery life” and “overall product rating” into a single maintained category. In such an embodiment, normalizer 602 may be configured to generate a single normalized product ratings from a single received mapped rating, in a similar fashion as was performed above with regard to the examples of the IPod Model X and Y products.

Referring back to FIG. 6, product review combiner 604 receives formatted product reviews and normalized product review ratings 608. Product review combiner 604 is configured to combine a plurality of ratings received for a product into a summary rating for the product. Product review combiner 604 generates aggregated product reviews 610, which contains the generated summary ratings.

For example, in an embodiment, combiner 604 may perform a simple averaging of the received ratings for a particular product, as follows:

summary rating for product=Σratings/# of ratings

In another embodiment, combiner 604 may perform a weighted averaging of the received ratings for a particular product to generate the summary rating, as follows:

summary rating for product=Σ(NRWi×rating(i))/# ratings,

where
NRWi=weight factor for rating i.
   Note that when normalizer 602 generates ratings for a plurality of categories related to a particular product, combiner 604 may combine the ratings for each particular category into separate summary ratings for each category and/or may combine together the ratings for the different categories to generate an overall summary rating.

In another embodiment, it may be desired to discount product reviews received from reviewers determined to have undesired reputations. For example, particular reviewers may be known to provide biased product reviews, either in a positive or negative manner, which can adversely affect the accuracy of summary ratings. Thus, it may be desired to discount product reviews received from such reviewers partially or entirely. A product review received from a reviewer having an undesired reputation may receive a weight factor, NRW, that is less than 1, or even equal to zero, if product reviews for that reviewer are desired to not be taken into account when calculating a summary rating.

In another embodiment, it may be desired to increase the weight of product reviews received from reviewers determined to have good reputations. For example, particular reviewers may be known to be independent and assessing products for consumer reports or audit.

A reputation of a reviewer may be determined in a variety of ways. For example, some websites provide with product reviews a reputation description for reviewers that submitted the product reviews. Thus, in an embodiment, such reputation information may be included in product reviews 108 provided from collector 102 to summary ratings generator 104 shown in FIG. 1. In an embodiment, product review combiner 604 may collect and store a list of received reviewer reputations, along with respective weight factors (e.g., NRW used above). The list may be searched for reviewers when calculating summary ratings to determine whether to discount particular product reviews.

As shown in FIG. 6, summary rating analyzer 606 receives product reviews 610 from product review combiner 604. Summary rating analyzer 606 is configured to analyze product review information and summary ratings generated for a product, to determine relevant statistics for the generated summary ratings. For example, summary rating analyzer 606 can be configured to determine a variety of statistics related to the summary rating for a particular product, including an error margin, a minimum rating value, a low quartile rating point, an average rating, a median rating, an upper quartile rating point, a maximum values rating, statistical significance of results, etc. Techniques for such statistical analysis will be well known to persons skilled in the relevant art(s). For example, an error margin may be calculated for a generated summary rating based on a total number of product reviews used to determine the summary rating.

Note that in an embodiment where product review combiner 604 generates summary ratings for multiple categories for a product, summary rating analyzer 606 may be configured to perform statistical analysis for each category.

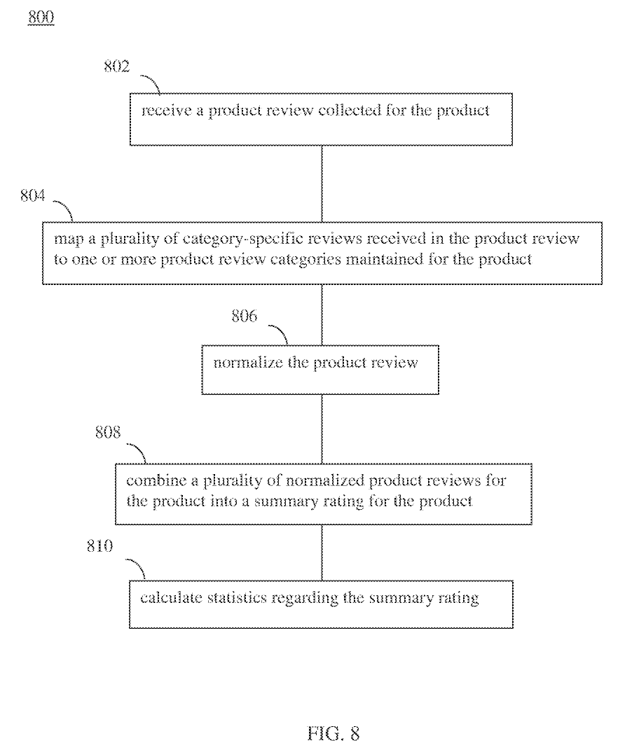

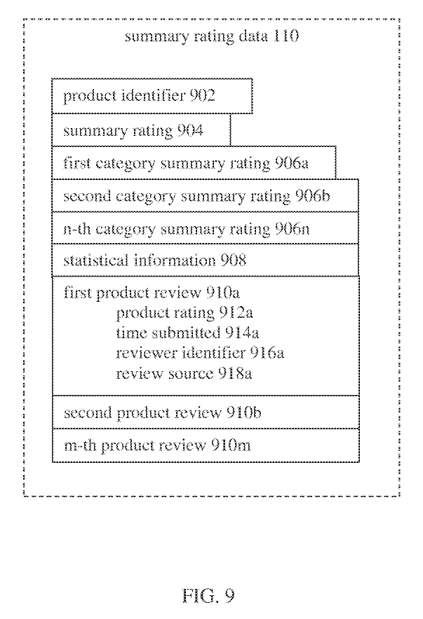

In an embodiment, summary ratings generator 104 may be configured to perform the steps shown in flowchart 800 of FIG. 8. The steps of flowchart 800 are described as follows. Not all of the steps of flowchart 800 are necessarily required to be performed in all embodiments.

Flowchart 800 starts with step 802. In step 802, a product review collected for the product is received. For example, as shown in FIG. 1, statistical ratings generator 104 receives product review 108 from collector 102.

In step 804, a plurality of category-specific reviews received in the product review are mapped to one or more product review categories maintained for the product. For example, step 804 may be performed by review category mapper 702 shown in FIG. 7.

In step 806, the product review is normalized. For example, step 806 may be performed by product review normalizer 602 shown in FIGS. 6 and 7.

In step 808, a plurality of normalized product reviews for the product are combined into a summary rating for the product. For example, step 808 may be performed by product review combiner 604 shown in FIG. 6.

In step 810, statistics for the summary rating are calculated. For example, step 810 may be performed by summary ratings analyzer 606 shown in FIG. 6.

Summary ratings generator 104 can be configured to generate summary rating data 110 in any suitable format, such as in a list form, array form, XML, JSON, or any other format. FIG. 9 shows an example of summary rating data 110 for a product, according to an embodiment of the present invention. As shown in FIG. 9, summary rating data 110 includes a product identifier 902, a summary rating 904, a first category summary rating 906a, a second category summary rating 906b, an n-th category summary rating 906n, statistical information 908, a first product review 910a, a second product review 910b, and an m-th product review 910m. Although the content of summary rating data 110 is shown in a specific order in FIG. 9 for illustrative purposes, it may be provided in any order.

Product identifier 902 identifies the product to which summary rating data 110 relates. Summary rating 904 is an overall product review rating for the product (e.g., generated by product review combiner 604). First through n-th category summary ratings 906a-906n are optionally present in summary rating data 110 when summary ratings are generated for a product in multiple product categories. Statistical information 908 is statistical information generated regarding summary rating 904 (e.g., generated by summary rating analyzer 606). First through m-th product reviews 910a-910m include information from individual product reviews collected by collector 104 for the product (e.g., are similar to product reviews 108). For example, as shown in FIG. 9, product review 910a includes a product rating 912a, a time submitted 914a, a reviewer identifier 916a, and a review source 918a. Product rating 912a is a rating for the product provided in the corresponding product review (e.g., 4 out of 5 stars, or a descriptive textual review, etc.). Time submitted 914a is time and/or date at which the corresponding product review was submitted (e.g., 11:30 am, Jul. 12, 2006). Reviewer identifier 916a is an identifier for the reviewer who submitted the product review (e.g., PLopez). Review source 918a is an identifier for a publisher of the product review, such as a website (e.g., www.yahoo.com).

Additional and/or alternative data may be provided in summary rating data 110. For example, each product review 910 may include product rating information (e.g., a rating value and/or a textual review description) for multiple product categories (e.g., sound, ease of use, portability, etc., in an Ipod example).

Referring back to FIG. 1, user interface 106 receives summary rating data 110 from summary ratings generator 104. In an embodiment, user interface 106 displays all or a selected portion of summary rating data 110.

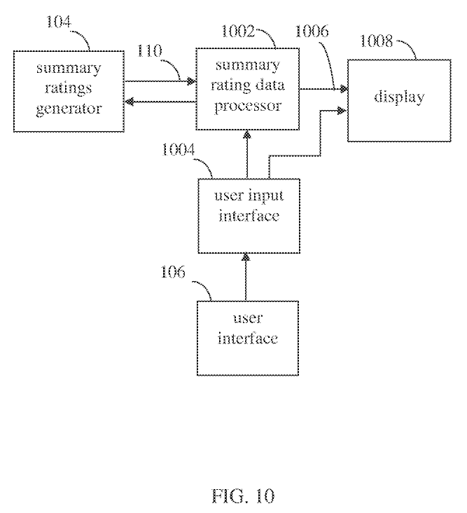

In an embodiment, as shown in FIG. 10, user interface 106 includes a summary rating data processor 1002 and a user input interface 1004. User input interface 1004 enables a user of system 100 to select summary rating data 110 for filtering prior to being displayed by display 1008. User input interface 1004 enables a user to select any combination of data provided in summary rating data 110 for display and/or enables a user to sort and/or filter data of summary rating data 110 in any manner. User input interface 1004 may include one or more user interface input elements such as a keyboard, a mouse, a touchpad, a rollerball, a GUI (graphical user interface) through display 1008, etc., to enable user input. Summary rating data processor 1002 receives summary rating data 110 and performs the data selection, sorting, and/or filtering, etc., requested by the user via user input interface 1004. As shown in FIG. 10, summary rating data processor 1002 generates processed summary rating data 1006, which is received by display 1008.

For example, in an embodiment, user input interface 1004 and summary data processor 1002 enable a user to display summary rating 904 for one or more products.

In another embodiment, user input interface 1004 and summary data processor 1002 enable a user to display each product review 910 for a product, including a product rating 912 (e.g., a rating value and/or a detailed textual review) and a review source (publisher) 918 for each product review 910. By displaying a publisher with each product review, the original publisher of the product review can be acknowledged and shown to a viewer of display 1008.

In another embodiment, user input interface 1004 and summary data processor 1002 enable a user to display each product review 910 for a selected review category for the product.

In another embodiment, user input interface 1004 and summary data processor 1002 enable a user to display each product review 910 for a selected product rating 912 and a selected review category for the product.

In another embodiment, user input interface 1004 and summary data processor 1002 enable a user to compare summary ratings 904 for a plurality of products in a selected product domain that have overlapping review categories. In this manner, a user is enabled to perform effective comparison shopping of similar products using more accurate and statistically significant aggregated review results, by comparing summary ratings 904 generated from a larger number of product reviews than in conventional systems. For example, in this manner a user could perform comparison shopping of music players, such an IPOD versus a RIO music player, to select the best reviewed music player. Summary ratings 904 for the different products may be compared, as well as category summary ratings 906 for the different products, when overlapping review categories are present.

In another embodiment, user input interface 1004 is configured to enable a user to weight ratings for a product based on a reviewer reputation and/or on a time at which product reviews were submitted. Thus, in such an embodiment, user input interface 1004 may be coupled to product review combiner 604 and summary rating analyzer 606, to weight product review ratings for reviewers and/or times. By weighting a summary rating based on reviewer reputation, product reviews by undesired reviewers can be discounted. Furthermore, the weight of product reviews by trusted reviewers may be enhanced, if desired. By weighting a summary rating based on a time at which reviews were submitted, some time periods of review can be discounted. For example, reviews submitted for a product during an early release for the product can be discounted, since the early release for the product may have included problems that are not present in later releases of the product.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for generating review information for products, comprising:
collecting product reviews for a product from multiple websites over the Internet;
generating at least one summary rating for the product based on the collected product reviews; and
displaying the at least one summary rating.

2. The method of claim 1, wherein said collecting comprises:
receiving a product catalog that lists a plurality of products in a product domain; and
crawling the Internet to collect product review information for the products.

3. The method of claim 2, wherein said collecting further comprises:
receiving the product catalog, wherein the product catalog lists product release information for each listed product; and
crawling the Internet to collect product review information for each release of the product.

4. The method of claim 2, wherein said collecting further comprises:
performing one or more of
parsing a Real Simple Syndication (RSS) feed for product reviews;
parsing website content on internet web sites for product reviews; or
parsing consumer reports for product reviews.

5. The method of claim 2, wherein said collecting comprises:
receiving data containing review information for the product;
locating a beginning of a product review for the product in the data;
locating an end of the product review in the data;
determining a time that the product review was submitted by a reviewer;
determining an identifier for the reviewer; and
determining one or more ratings for the product.

6. The method of claim 1, wherein said generating at least one summary rating for the product based on the collected product reviews comprises:
receiving product reviews collected for the product from different websites, the received product reviews including product review ratings;
normalizing the product review ratings;
determining a reputation for at least one reviewer that submitted a collected a product review;
weighting product review ratings submitted by a reviewer based on a reputation of the reviewer; and
combining a plurality of normalized product reviews for the product into a summary rating for the product.

7. The method of claim 6, wherein said receiving the product review comprises:
receiving a plurality of category-specific reviews and ratings for the product in the product review.

8. The method of claim 6, wherein said normalizing the product review ratings comprises:
mapping the plurality of category-specific review ratings for the product to one or more product review rating categories maintained for the product; and
normalizing review ratings for each of the one or more maintained product review categories.

9. The method of claim 6, wherein said combining comprises:
weighting the plurality of product review ratings for the product.

10. The method of claim 6, wherein said combining comprises:
combining a plurality of normalized product review ratings for each of a plurality of maintained review categories for the product to generate corresponding summary ratings for the maintained review categories.

11. The method of claim 6, wherein said combining further comprises:
combining the summary ratings for the plurality of maintained review categories into an overall summary rating for the product.

12. The method of claim 6, wherein said generating at least one summary rating for the product based on the collected product reviews comprises:
determining statistics regarding the summary rating.

13. The method of claim 1, wherein said displaying the at least one summary rating comprises at least one of:
enabling a user to display a plurality of product reviews collected for the product and a publisher for each of the plurality of product reviews;
enabling a user to display a plurality of product reviews for a selected review category maintained for the product;
enabling a user to display a plurality of product reviews for a selected rating and a selected review category maintained for the product;
enabling a user to display a plurality of product reviews for geographic regions maintained for the product;
enabling a user to display a plurality of product reviews for user demographic segments maintained for the product;
enabling a user to display a plurality of product reviews for a manufacturer for the product;
enabling a user to display a plurality of product reviews for distributors for the product;
enabling a user to display a plurality of product reviews for customer support for the product;
enabling a user to display statistical information on ratings for a product;
enabling a user to weight a summary rating for a product based on reviewer reputation;
enabling a user to weight a summary rating for a product based on a release date of the product;
enabling a user to weight a summary rating for a product based on a time at which product reviews were submitted; or
enabling a user to compare summary ratings for a plurality of products in a selected product domain that have overlapping review categories.

14. A system for generating review information for products, comprising:
a product review information collector configured to collect product reviews provided at multiple websites over the Internet;
a summary ratings generator configured to generate one or more summary ratings for products based on collected product reviews for the products; and
a user interface configured to display summary ratings for products.

15. The system of claim 14, wherein the product review information collector comprises:
a machine learning algorithm module configured to learn predicates to determine whether collected content includes a product review.

16. The system of claim 14, wherein the product review information collector comprises:
a machine learning algorithm module configured to learn predicates to determine product review ratings.

17. The system of claim 14, wherein the product review information collector comprises:
a information parser configured to determine whether collected content includes a product review using the names of the selected product and at least one adjective and at least one noun.

18. The system of claim 14, wherein the product review information collector comprises:
a product review information parser configured to receive data containing review information for a selected product, and to locate a beginning and an end of a product review for the selected product in the data;
wherein the product review information parser is further configured to determine a time that the product review was submitted by a reviewer, and to determine an identifier for the reviewer.

19. The system of claim 14, wherein the summary ratings generator comprises:
a product review normalizer configured to receive product reviews collected for products, and to normalize the received product reviews.

20. The system of claim 14, wherein the summary ratings generator comprises:
a review category mapper configured to receive a plurality of category-specific reviews for products, and to map the plurality of category-specific reviews for the products to one or more product review categories maintained for products.

21. The system of claim 17, wherein the summary ratings generator is configured to discount product reviews received from reviewers determined to have undesired reputations.

22. The system of claim 19, wherein the summary ratings generator further comprises:
a product review combiner configured to combine a plurality of normalized product reviews for each product into a summary rating for each product.

23. The system of claim 20, wherein the summary ratings generator further comprises:
a summary rating analyzer configured to determine statistics regarding the summary ratings.

24. The system of claim 14, wherein the user interface is configured to enable a user to display each product review and a publisher for each product review for a product, to display each product review for a selected review category for the product, to display each product review for a selected rating and selected review category for the product, to weight a summary rating for the product based on a reviewer reputation, to weight a summary rating for the product based on a time at which product reviews were submitted, and to compare summary ratings for a plurality of products in a selected product domain that have overlapping review categories.

25. A computer program product comprising a computer usable medium having computer readable program code means embodied in said medium for generating review information for products, comprising:
a first computer readable program code means for enabling a processor to collect product reviews for a product from multiple websites over the Internet;
a second computer readable program code means for enabling a processor to generate at least one summary rating for the product based on the collected product reviews; and
a third computer readable program code means for enabling a processor to display the at least one summary rating.
